(19) United States
(12) Patent Application Publication
(10) Pub. No.: US 2013/0263440 A1
(43) Pub. Date: Oct. 10, 2013

(54) METHOD FOR MANUFACTURING INDUCTOR

(71) Applicant: SAMSUNG ELECTRO-MECHANICS CO., LTD, Suwon (KR)

(72) Inventors: Sang Moon Lee, Seoul (KR); Jung Min Park, Gyeonggi-do (KR); Sung Kwon Wi, Seoul (KR); Young Seuck Yoo, Seoul (KR); Yong Suk Kim, Gyeonggi-do (KR)

(21) Appl. No.: 13/723,764

(22) Filed: Dec. 21, 2012

(30) Foreign Application Priority Data
Dec. 22, 2011 (KR) 10-2011-0140412

(51) Int. Cl. H01F 41/04; H01F 41/06

(52) U.S. Cl. CPC H01F 41/04; H01F 41/0604
USPC 29/605; 29/602.1

(57) ABSTRACT

Disclosed herein is a method for manufacturing an inductor, including: forming a coil laminate by inserting spiral coils into a guide shaft disposed at a center of a magnetic substrate; providing a molding part so as to surround the coil laminate; removing the guide shaft; and providing a ferrite composite so as to surround the molding part.

### CROSS REFERENCE(S) TO RELATED APPLICATIONS

This application claims the benefit under 35 U.S.C. Section 119 of Korean Patent Application Serial No. 10-2011-0140412 entitled “Method For Manufacturing Inductor” filed on Dec. 22, 2011, which is hereby incorporated by reference in its entirety into this application.

### BACKGROUND OF THE INVENTION

1. Technical Field

The present invention relates to a method for manufacturing an inductor, and more particularly, to a method for manufacturing an inductor capable of miniaturizing a product and improving performance by improving impedance characteristics and implementing high inductance.

2. Description of the Related Art

With the miniaturization of electronic devices, a demand for miniaturization and lightness of electronic components used for the electronic devices has increased.

However, a relative volume ratio of a power supply circuit used for the electronic devices is being increased in response to an increase in the entire volume of electronic devices, which can implement various types of high-speed and high-integration LSIs in addition to a CPU used for various electronic circuits but makes it difficult to miniaturize magnetic components such as an inductor, a transformer, and the like, that are essential circuit elements of the power supply circuit.

The magnetic components such as the inductor and the transformer are miniaturized and thus, when a volume of a magnetic substance is reduced, a magnetic core is easily magnetic-saturated, such that there is a problem in that a current amount that can be handled by a power supply may be reduced.

Here, an example of a magnetic substance used to manufacture the inductor may include ferrites and metal magnetic substances and a multilayered chip type inductor that is advantageous in mass production and miniaturization has mainly used ferrite-based magnetic materials.

However, the ferrite has high permeability and electric resistance but low magnetic flux density. Therefore, when the ferrite itself is used, the degradation in inductance is large and DC overlapping characteristics are deteriorated, due to the magnetic saturation.

Therefore, as the chip type inductance according to the related art, a winding type inductor formed by winding a wire around metal magnetic-based materials having large loss and low electric resistance but high saturation magnetic flux density has been mainly used and multilayered products have a very small usable current range.

Referring to Korean Patent Laid-Open Publication No. 2011-0083325 (laid-open published on Jul. 20, 2011) as the related document in which the winding type inductor according to the related art is disclosed, as a method for manufacturing an inductor according to the related art, there is a method for directly winding coils around a drum core and soldering ends of the wound coils to electrodes disposed on the drum core.

However, the winding type inductor according to the related art has a disadvantage in that a winding thickness of a coil is limited due to a limitation of a size and a shape of the drum core.

To this end, a method for forming coils using a photo exposure method has been used, but even in this case, there is a problem in that it is difficult to reduce an interval between coils to a predetermined interval.

### SUMMARY OF THE INVENTION

An object of the present invention is to provide a method for manufacturing an inductor capable of further miniaturizing products than a winding type inductor according to a method for winding a coil around a bobbin.

Another object of the present invention is to provide a method for manufacturing an inductor capable of performance and reliability by improving impedance characteristics and implementing high inductance by reducing an interval between coils.

According to an exemplary embodiment of the present invention, there is provided a method for manufacturing an inductor, including: forming a coil laminate by inserting spiral coils into a guide shaft disposed at a center of a magnetic substrate; providing a molding part so as to surround the coil laminate; removing the guide shaft; and providing a ferrite composite so as to surround the molding part.

The spiral coil may be manufactured by winding a coil sheet coated with an insulating layer.

The insulating layer may be made of an insulating polymer including epoxy or polyimide and the coil sheet may be made of copper (Cu).

The coil sheet may have a thickness of 100 to 200 μm and the insulating layer may have a thickness of 2 to 10 μm.

The magnetic substrate may be made of a ferrite material and a metal material.

The magnetic substrate may be made of Fe, Fe₂O₃, NiO, CuO, ZnO, and MnO.

A surface of the magnetic substrate may be coated with an insulating polymer. The insulating polymer may be coated at a thickness of 5 to 10 μm.

The guide shaft may have a releasing property.

The guide shaft may have the releasing property by being subjected to at least any one of self-assembled monolayers (SAM) coating and Teflon coating, or including a silicon releasing agent.

The molding part may be made of an insulating material.

The forming of the coil laminate may include providing a plurality of spiral coils electrically connected with each other on an upper surface and a lower surface of the magnetic substrate based on the magnetic substrate by inserting the spiral coils into both sides of the guide shaft, respectively.

The method for manufacturing an inductor may further include: after the removing of the guide shaft, electrically connecting the plurality of spiral coils through a space in which the guide shaft is removed.

The ferrite composite may be filled up to the space in which the guide shaft is removed.

The ferrite composite may include a ferrite material, a resin, and a hardener.

The resin may include any one of epoxy, bisphenol, novalac, and phenoxy.

### BRIEF DESCRIPTION OF THE DRAWINGS

FIGS. 1 to 9 are cross-sectional views schematically illustrating a method for manufacturing an inductor according to an exemplary embodiment of the present invention, wherein:

FIG. 1 is a cross-sectional view illustrating a coil sheet,

FIG. 2 is a cross-sectional view illustrating a state in which an insulating layer is coated on one surface of the coil sheet of FIG. 1,

FIG. 3 is a cross-sectional view illustrating a state in which the coil sheet of FIG. 2 is wound,

FIG. 4 is a cross-sectional view illustrating a magnetic substrate of which the surface is coated with an insulating polymer,

FIG. 5 is a cross-sectional view illustrating a state in which a center of the magnetic substrate of FIG. 4 is provided with a guide shaft,

FIG. 6 is a cross-sectional view illustrating a coil laminate in which a plurality of spiral coils are inserted and stacked into both sides of the guide shaft,

FIG. 7 is a cross-sectional view illustrating a state in which a molding part is disposed on the coil laminate of FIG. 6,

FIG. 8 is a cross-sectional view illustrating a state in which the guide shaft of FIG. 7 is removed and the plurality of spiral coils are electrically connected with each other, and

FIG. 9 is a cross-sectional view illustrating a state in which a ferrite composite is formed in the coil laminate including the molding part of FIG. 8.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes. For example, an etching region vertically shown may be rounded or may have a predetermined curvature. Therefore, the illustrated regions in the drawings have schematic attributes, and the shapes of the illustrated regions in the drawings are for illustrating specific shapes and are not for limiting the scope of the present invention.

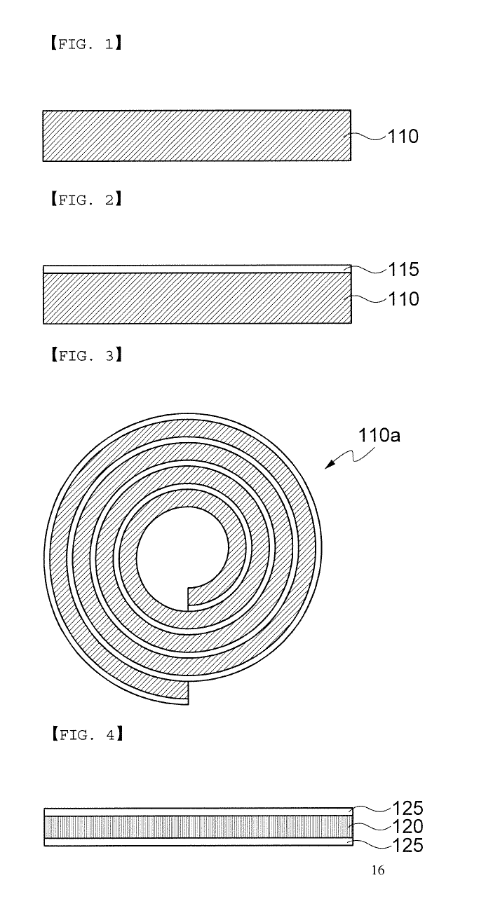

Hereinafter, a method for manufacturing an inductor according to an exemplary embodiment of the present invention will be described in more detail with reference to FIGS. 1 to 9.

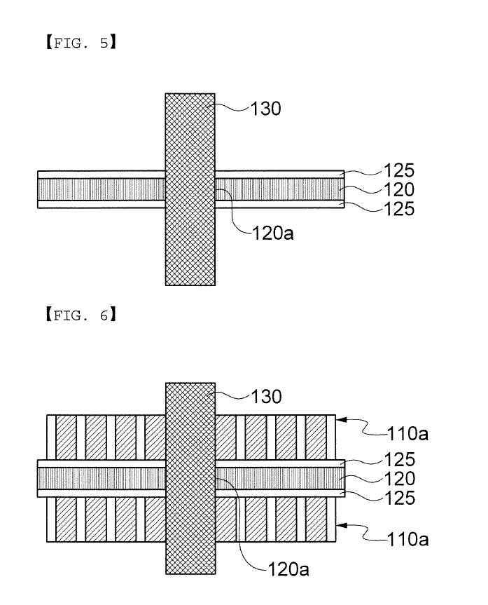

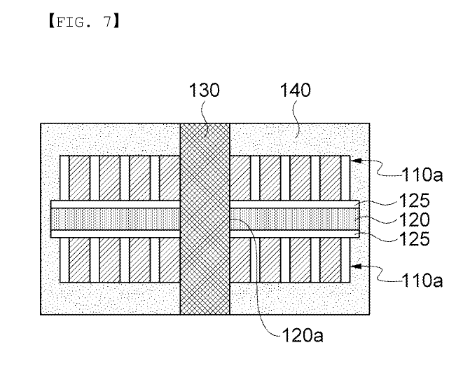

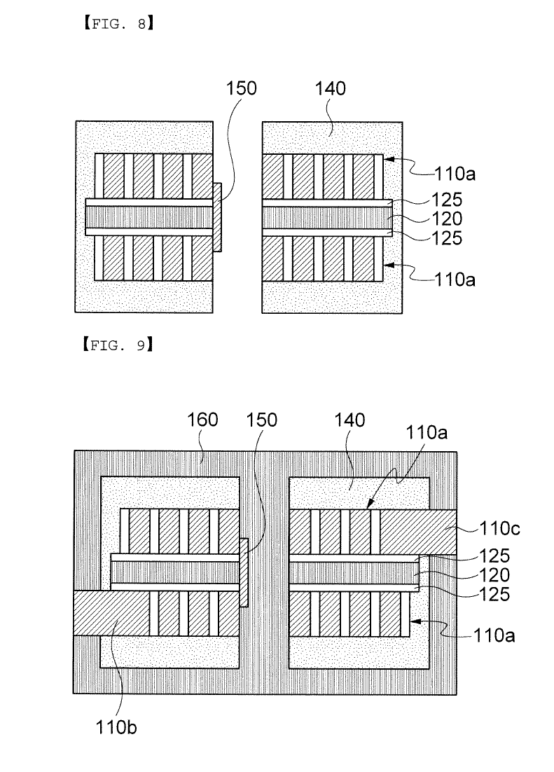

FIGS. 1 to 9 are cross-sectional views schematically illustrating a method for manufacturing an inductor according to an exemplary embodiment of the present invention, wherein FIG. 1 is a cross-sectional view illustrating a coil sheet, FIG. 2 is a cross-sectional view illustrating a state in which an insulating layer is coated on one surface of the coil sheet of FIG. 1, FIG. 3 is a cross-sectional view illustrating a state in which the coil sheet of FIG. 2 is wound, FIG. 4 is a cross-sectional view illustrating a magnetic substrate of which the surface is coated with an insulating polymer, FIG. 5 is a cross-sectional view illustrating a state in which a center of the magnetic substrate of FIG. 4 is provided with a guide shaft, FIG. 6 is a cross-sectional view illustrating a coil laminate in which a plurality of spiral coils are inserted and stacked into both sides of the guide shaft, FIG. 7 is a cross-sectional view illustrating a state in which a molding part is disposed on the coil laminate of FIG. 6, FIG. 8 is a cross-sectional view illustrating a state in which the guide shaft of FIG. 7 is removed and the plurality of spiral coils are electrically connected with each other, and FIG. 9 is a cross-sectional view illustrating a state in which a ferrite composite is formed in the coil laminate including the molding part of FIG. 8.

First, as illustrated in FIG. 1, according to the method for manufacturing an inductor according to the exemplary embodiment of the present invention, a coil sheet 110 made of a conductive metal material such as copper (Cu) is prepared.

Next, as illustrated in FIG. 2, an insulating layer 115 is disposed on one surface of the coil sheet 110.

Here, the insulating layer 115 may be made of an insulating polymer including epoxy or polyimide and may be provided by coating one surface of the coil sheet 110 with the insulating polymer.

In this case, the coil sheet 110 may have a thickness of approximately 100 to 200 μm and the insulating layer 115 may have a thickness of approximately 2 to 10 μm.

Next, as illustrated in FIG. 3, spiral coils 110a are manufactured by winding the coil sheet 110.

That is, the spiral coils 110a are manufactured by winding the coil sheet 110. In this case, it is possible to insulate between adjacent portions of the spiral coils 110a through the insulating layer 115.

Next, as illustrated in FIG. 4, a magnetic substrate 120 is prepared.

In this case, the magnetic substrate 120 may be made of a ferrite material and a metal material.

As an example, the magnetic substrate 120 may be made of Fe, Fe₂O₃, NiO, CuO, ZnO, and MnO.

Here, a surface of the magnetic substrate 120 may be coated with an insulating polymer 125. In this case, the insulating polymer 125 may be coated at a thickness of 5 to 10 μm.

Next, as illustrated in FIG. 5, a center of the magnetic substrate 120 is provided with a guide hole 120a and a guide shaft 130 is inserted into the guide hole 120a.

Here, the guide shaft 130 may have a releasing property.

For example, a surface of the guide shaft 130 is subjected to self-assembled monolayers (SAM) coating and teflon coating or may be configured including a silicon releasing agent to have a releasing property.

Next, as illustrated in FIG. 6, the spiral coils 110a are each inserted into both sides of the guide shaft 130 that is disposed at a center of the magnetic substrate 120 to form a coil laminate.

That is, the spiral coils 110a are each stacked on an upper portion and a lower portion of the magnetic substrate 120.

Next, as illustrated in FIG. 7, a molding part 140 is provided so as to surround the coil laminate configured as described above.

That is, the coil laminate is molded with an insulating material such as polyimide or epoxy.

In this case, both ends of the guide shaft 130 may be exposed to the outside of the molding part 140.

Next, as illustrated in FIG. 8, the guide shaft 130 is removed.

In this case, since the guide shaft 130 has the releasing property, any one of both ends of the guide shaft 130 exposed to the outside of the molding part 140 is pressed and thus, may be removed from the coil laminate.

Next, the spiral coils 110a each disposed on an upper surface and a lower surface of the magnetic substrate 120 are electrically connected with each other through a space in which the guide shaft 130 is removed.

In this case, the electrical connection between the spiral coils 110a may be made through a coil connector 150 made of a conductive material such as copper (Cu).

Next, as illustrated in FIG. 9, a ferrite composite 160 is disposed so as to surround the molding part 140.

Here, the ferrite composite 160 may be configured including a ferrite material, a resin, and a hardener.

In this case, the resin may be made of any one of epoxy, bisphenol, novalac, and phenoxy, wherein the hardener may be made of polyamide or amine.

Meanwhile, the ferrite composite 160 may be filled up to a space in which the guide shaft 130 is removed.

Further, an input pattern 110b and an output pattern 110c for electrical input and output of the spiral coils 110a may be exposed to the outside of a side of the ferrite composite 160.

In this case, the input/output patterns 110b and 110c themselves may also be external terminals and the external terminals may also be formed by connecting separate electrodes to the input/output patterns 110b and 110c.

As set forth above, according to the method for manufacturing an inductor according to the exemplary embodiments of the present invention, it is possible to further increase the thickness of the coil than the winding type inductor according to the method for winding the coils around the bobbin and densely form the interval between the coils, thereby implementing the miniaturization of products.

Further, according to the method for manufacturing an inductor according to the exemplary embodiments of the present invention, it is possible to improve the impedance characteristics and implement the high inductance by densely forming the interval between the coils while maintaining the thickness of the coil, thereby improving the performance and reliability of products.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method for manufacturing an inductor, comprising:
forming a coil laminate by inserting spiral coils into a guide shaft disposed at a center of a magnetic substrate;
providing a molding part so as to surround the coil laminate;
removing the guide shaft; and
providing a ferrite composite so as to surround the molding part.

2. The method according to claim 1, wherein the spiral coil is manufactured by winding a coil sheet coated with an insulating layer.

3. The method according to claim 2, wherein the insulating layer is made of an insulating polymer including epoxy or polyimide and the coil sheet is made of copper (Cu).

4. The method according to claim 3, wherein the coil sheet has a thickness of 100 to 200 μm and the insulating layer has a thickness of 2 to 10 μm.

5. The method according to claim 1, wherein the magnetic substrate is made of a ferrite material and a metal material.

6. The method according to claim 5, wherein the magnetic substrate is made of Fe, Fe₂O₃, NiO, CuO, ZnO, and MnO.

7. The method according to claim 1, wherein a surface of the magnetic substrate is coated with an insulating polymer.

8. The method according to claim 7, wherein the insulating polymer is coated at a thickness of 5 to 10 μm.

9. The method according to claim 1, wherein the guide shaft has a releasing property.

10. The method according to claim 9, wherein the guide shaft has the releasing property by being subjected to at least any one of self-assembled monolayers (SAM) coating and Teflon coating, or including a silicon releasing agent.

11. The method according to claim 1, wherein the molding part is made of an insulating material.

12. The method according to claim 1, wherein the forming of the coil laminate includes providing a plurality of spiral coils electrically connected with each other on an upper surface and a lower surface of the magnetic substrate based on the magnetic substrate by inserting the spiral coils into both sides of the guide shaft, respectively.

13. The method according to claim 12, further comprising:
after the removing of the guide shaft, electrically connecting the plurality of spiral coils through a space in which the guide shaft is removed.

14. The method according to claim 1, wherein the ferrite composite is filled up to the space in which the guide shaft is removed.

15. The method according to claim 1 or 14, wherein the ferrite composite includes a ferrite material, a resin, and a hardener.

16. The method according to claim 15, wherein the resin includes any one of epoxy, bisphenol, novalac, and phenoxy.

17. The method according to claim 15, wherein the hardener includes polyamide or amine.
